(19) United States
(12) Patent Application Publication
(10) Pub. No.: US 2005/0149482 A1
(43) Pub. Date: Jul. 7, 2005

(54) Method of updating a database created with a spreadsheet program

(75) Inventor: Patrick Dillon, Versailles (FR)

Correspondence Address: LOWE HAUPTMAN GILMAN & BERNER, LLP, 1700 DIAGNOSTIC ROAD, SUITE 300, ALEXANDRIA, VA, 22314, US

(73) Assignee: THALES, Neuilly Sur Seine (FR)

(21) Appl. No.: 10/998,174

(22) Filed: Nov. 29, 2004

(30) Foreign Application Priority Data
Dec. 19, 2003 (FR) 0315027

(51) Int. Cl. G06F 7/00

(52) U.S. Cl. 707/1

(57) ABSTRACT

The present invention concerns a method of updating a database created with a spreadsheet program, for example with the Excel computer program. The manipulation of databases in a spreadsheet program may be a source of errors and lack user-friendliness to ensure that it is efficiently used. The main object of the invention is to ensure a uniformity and to facilitate the task of a user in the creation and maintenance of such a database. Accordingly, the object of the invention is an updating method. The data of the database are located in a first range of cells, and update parameters are located in a second range of cells. At least one updating function is applied to a determined set of cells of the first range of cells, each updating function using update parameters contained in determined cells of the second range of cells.

### FIELD OF THE INVENTION

The present invention concerns a method of updating a database created with a spreadsheet program, for example with the Excel computer software. The invention applies to databases used to design, manage and deploy architectures based on complex computer systems.

### DESCRIPTION OF THE PRIOR ART

A database represents a set of information that can be managed by a computer software program called a database management system (DBMS). Such programs include Oracle, Ingres, O₂, etc. Various processing programs can manipulate data extracted from a database. Thus data is shared between various processing programs, the data being updated in centralized manner with a DBMS. However, DBMSs are complex both from the point of view of their installation and their maintenance and from the point of view of their use.

In certain applications, the data are managed only by a single processing program. Use may then be made of spreadsheet programs, such as Excel, that are easier programs to use than a DBMS. Spreadsheet programs can be used to carry out elaborate processes on data. More precisely, a spreadsheet program is a program that allows the presentation of data in table and graph form with a predisposition to the automation of computations on these data.

A spreadsheet program can be used to process two-dimensional tables of data. A basic element of the table, located by a determined line and column, is called a cell. Each cell of a table can be referenced by an address, that is to say a unique identifier made up of the number of the line and of the column to which the cell belongs.

A cell contains a data item of a table, for example text (character string), a numerical value, a date, etc. The data item contained in a cell is called the value of that cell. The value of a cell may be the result of a computing function, this function being associated with the cell. The function is defined by a formula, for example a mathematical expression. The function may use as an argument references to other cells, these references being replaced by the values of the corresponding cells to perform the computation.

Spreadsheet programs provide simple functions (sorting, requesting, summarizing) to exploit nonrelational databases, a database being formed by a set (or range) of cells as shown in FIG. 1. However, the processing of databases in a spreadsheet program may be a source of errors and lack user-friendliness to ensure efficient use. The main object of the invention is to ensure a uniformity and to facilitate the task of a user in the creation and maintenance of such a database.

### SUMMARY OF THE INVENTION

Accordingly, the object of the invention is a method of updating that can be used to format the database according to a description given by the user. According to the invention, the data of the database are located in a first range of cells, and update parameters are located in a second range of cells. At least one updating function is applied to a determined set of cells of the first range of cells, each updating function using update parameters contained in determined cells of the second range of cells.

### BRIEF DESCRIPTION OF THE DRAWINGS

Other features and advantages of the invention will appear on reading the following detailed description given as a nonlimiting illustration and made with reference to the appended figures which represent:

FIG. 1, a detail view of an example of a spreadsheet, this view showing an range of cells containing a database,

FIG. 2, an overview of the spreadsheet shown in FIG. 1, this overview also showing update parameters,

FIG. 3, a detail view of the update parameters.

### MORE DETAILED DESCRIPTION

Certain spreadsheet programs, such as Excel, can be used to process data of several tables, these tables being able to be saved in a single file. In such a file containing several tables, the entity containing each table within the file is called a sheet or else a spreadsheet.

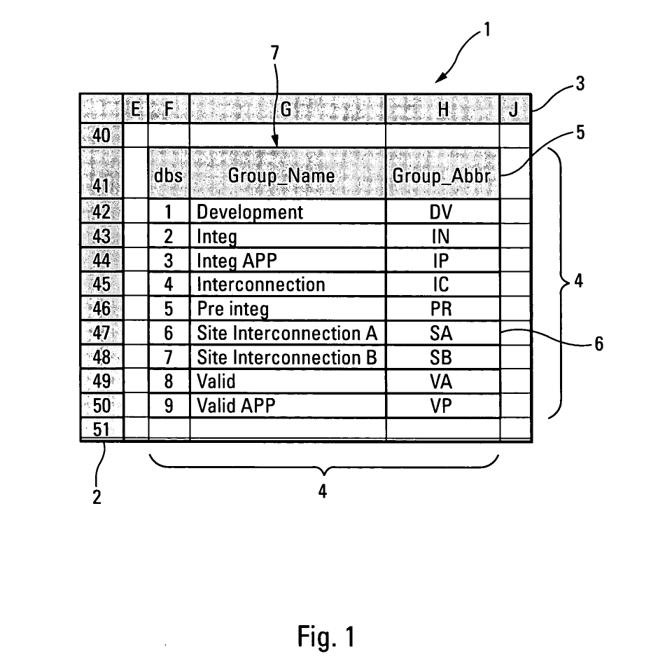

Reference will now be made to FIG. 1 which represents a portion of a spreadsheet 1. The spreadsheet comprises lines and columns. The lines are referenced by whole numbers 2, these whole numbers forming a sequence increasing from top to bottom of the spreadsheet. The columns are referenced by code letters 3, these codes letters representing base whole numbers 26, these whole numbers forming a sequence increasing from left to right of the spreadsheet. In the rest of the description, the references using these whole numbers and these code letters are shown between quotation marks to avoid any confusion with the references to the drawings.

This spreadsheet comprises a first range of cells 4, that is to say a rectangular zone of the spreadsheet. The range of cells 4 in this example extends from line “41” to line “50” and from column “F” to column “H”. This range of cells may be referred to by the usual notation of spreadsheet programs, that is to say by “F41:H50”.

This first range of cells 4 comprises data of a database. The first line 5, which may also be referred to by “F41:H41”, comprises field names. The following lines, such as line 6, contain records of the database. In this example, the database comprises nine records. Each column corresponds to a field of the database. Thus, column 7 corresponds to the field called “Group_Name”. For example, the “Group_Name” field of the sixth record 6 comprises the data “Site Interconnection B”, this data being of text type.

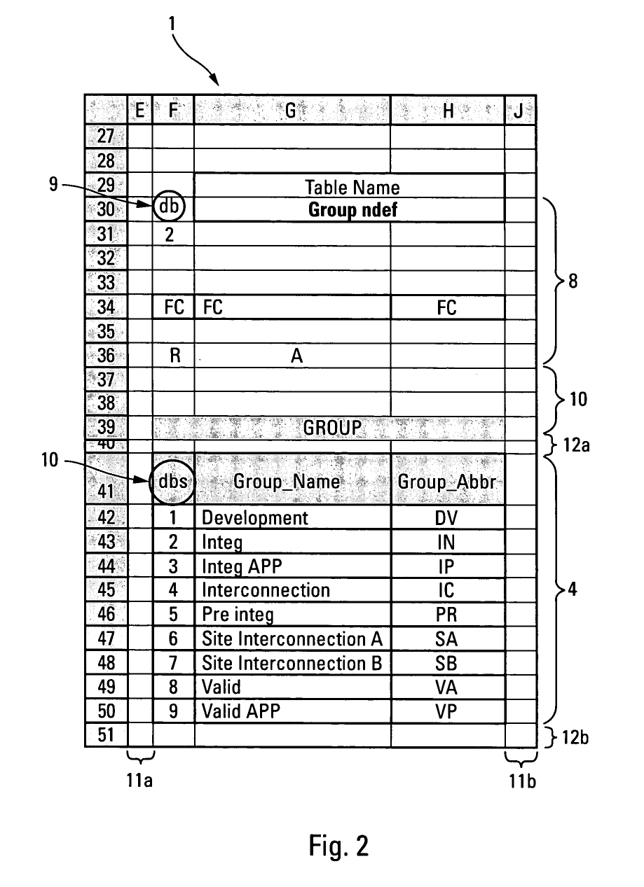

Reference is now made to FIG. 2. A second range of cells 8 is situated above the first range of cells. The second range 8 extends from lines “30” to “36” and from columns “F” to “H”. This can be referred to by “F30:H36”. The second range of cells 8 comprises update parameters used by the updating method according to the invention. In this exemplary embodiment, the second range of cells comprises seven lines.

More precisely, the update parameters are used by updating functions, each updating function being applied to a determined set of cells of the first range of cells, each updating function using update parameters contained in determined cells of the second range of cells.

In order that the first and second range of cells can be located, location markers, that is to say predetermined codes, are defined. In this example, the codes are character strings, the character string “db” forming the location marker of the second range of cells, the character string “dbs” forming the location marker of the first range of cells.

In this example, the location markers are positioned in the cell of the first line and of the first column of each range of cells. Thus, the location marker “db” is positioned in the cell 9, this cell also bearing the reference “F30”. Similarly, the location marker “dbs” is positioned in the cell 10, this cell also bearing the reference “F41”. In either case, the position of the first and second ranges of cells is determined by searching for these location markers, this search being made before applying the updating functions.

This allows the ranges of cells to be positioned freely in a spreadsheet. Lines of comments 10 may also thus be inserted between the second range of cells 8 and the first range of cells 4. In addition, this can be used to place several databases on one and the same spreadsheet, the position of these databases being capable of being determined automatically.

In this example, the first and second ranges of cells belong to one and the same spreadsheet, that is to say one and the same table. According to a variant embodiment, the first and second ranges of cells can be placed in different spreadsheets. One of the update parameters of the second range of cells may for example contain the name of the spreadsheet in which the first range of cells is placed.

Preferably, the first range of cells, that is to say the range corresponding to the database, is surrounded by empty cells. Lines 12a and 12b of empty cells are provided respectively above and below the range of cells 4. Similarly, columns 11a and 11b of empty cells are provided respectively to the left and to the right of the range of cells 4. This allows this range of cells to be more easily manipulated by using the basic functions of the spreadsheet program, most spreadsheet programs considering that such an arrangement of cells forms a database. The basic functions of the spreadsheet program can then be used to manipulate these data (sort, search, extract, summarize, etc.).

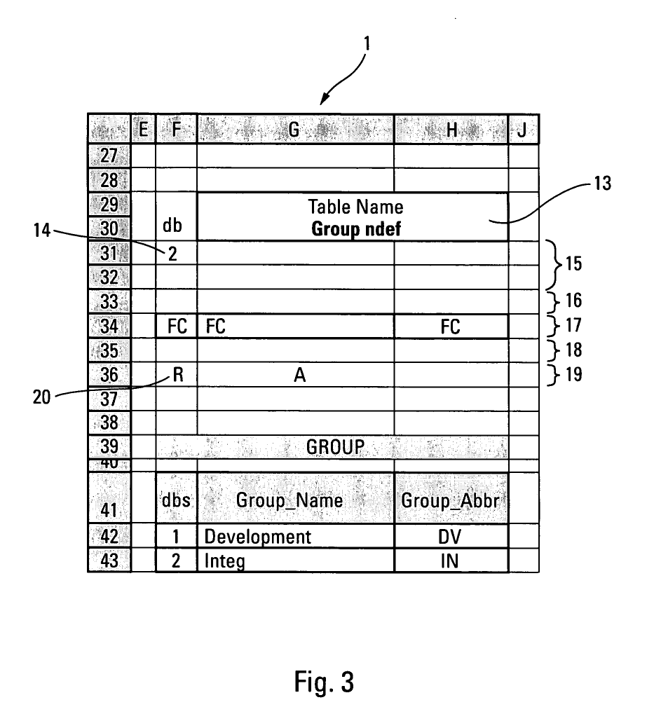

Reference is now made to FIG. 3. The updating functions may be applied column by column to the database, by using different update parameters for each column.

The update parameters used by such an updating function are preferably located in cells whose position is determined relative to the location marker “db” of the second range of cells. For example, the parameters of such an updating function may be contained in the line 18, this line also bearing the reference “35” in the spreadsheet. When such an updating function is applied to a given column of the database, the update parameter or parameters are located in a corresponding column of these parameter lines.

According to another embodiment, the update parameters are located in cells comprising individual location markers. In most spreadsheet programs, a comment zone, whose content is text, is associated with each cell. The location markers may then be placed in the comment zone of these cells.

According to an advantageous embodiment, when the first and second ranges of cells are placed in one and the same spreadsheet, the update parameters are located in the column to which said updating function is applied. This can be generalized when the first and second ranges of cells are placed in different spreadsheets.

More generally, the columns in which the update parameters are located are arranged in the same order as the columns of the first range of cells for which these update parameters are used.

There now follows a description of the examples of updating functions applied column by column. These updating functions are used, for example, to manage more simply databases containing computed fields, databases in which the content of certain fields is limited to a determined list, and to format and protect database fields in a uniform manner.

A computed field is a field whose content is the result of a formula, such as a mathematical expression, a character string process or a search function in a database of a spreadsheet program. This formula usually uses arguments contained in this database or in other databases. Databases containing computed fields are not managed by spreadsheet programs. It is possible to assign a formula to cells individually, but this formula cannot be assigned to an entire column of a database.

To keep a database containing computed fields up to date, the user must, each time a new record is added, remember to copy the appropriate formulae into the computed fields of this new record. If the user forgets to copy a formula, the database will contain incorrect data which will be increasingly difficult to detect as the number of records increases. Furthermore, if the user wishes to modify the formula of a computed field, he must make this modification in all the records.

An updating function can be used to solve these problems. This updating function uses a parameter line 18, this line having the reference “35” in the spreadsheet shown as an example. Each cell of the line may contain a formula or no formula. The updating function is applied to the database cells located in the columns for which the corresponding cell of the parameter line effectively contains a formula. For example, if the cell having the reference “G35” contains a formula, the updating function is applied to the cells of column “G” of the database.

Application of the updating function consists, at least for each of these columns, in copying the formula contained in said corresponding cell of the parameter line into the cells of the database column in question. The formula contained in the cell “G35” will thus be copied into all the cells of the column “G” of the database (with the exception of the line containing the field names of course), that is to say into the cells “G42” to “G50”.

There now follows a description of another example of an updating function applied column by column.

A database may contain a field linked to another database or more generally to a list. The linked field contains a data item originating from the database or from the list to which it is linked. In order to make these links, DBMSs use relational databases, that is to say databases in which the linked fields contain a reference to a field of a record of another database. However, the very concept of relational database does not exist in spreadsheet programs.

There is in spreadsheet programs a function known as validation, which is used to specify which data are valid for individual cells or ranges of cells. This validation function is used in particular, during the outputting of the content of a cell, to restrict the inputting into the cells to the data from a list, hereafter known as a validation list. In practice, a pop-up list may appear during the outputting of such a cell. The validation list, that is to say the list of valid inputs, may be contained in a column or in a line.

For example, a validation list may be assigned to an range of cells forming a field (a column) of the database. However, when this range increases because of the addition of records, the validation function will not be assigned to the cells of the new records. The database user must then either restrict himself to entering only data from the validation list (without the help of the validation function), or assign the validation function to the new range of cells.

An updating function can be used to solve these problems. This updating function uses a parameter line 16, this line having the reference “33” in the spreadsheet shown as an example. Each cell of the line may contain a reference to a validation list. The reference may for example be a reference to an range of cells, using the convention of spreadsheet programs (for example “R42:R47”, if the validation list is contained in the lines “42” to “47” of the column “R”), a name given to an range of cells, or else a name given to a field of a database.

The updating function is applied to the database cells located in the columns for which the corresponding cell of the parameter line effectively contains a reference to a validation list. For example, if the cell having as its reference “H33” contains a reference to a list, the updating function is applied to the cells of the column “H” of the database.

The application of the updating function consists, at least for each of these columns, in assigning the validation list whose name is contained in said corresponding cell of the parameter line to the cells of the database column in question.

According to a variant of embodiment, one and the same parameter line may be used for both updating functions (formula and validation list). Specifically, a field contains either computed data, or input data. Consequently, a validation list and a formula cannot exist at the same time in one and the same column. The updating functions described will operate in the same manner, the cells of the parameter line being able to contain either a formula, or a reference to a validation list, or another type of data (not considered), or to be empty.

Another example will now be described of an updating function applied column by column.

A spreadsheet program is used to display the cells with a particular formatting for each cell. This formatting may relate for example to the formatting of the display of the numbers (in the form of money, date, with a certain precision, etc.), the alignment in the cell (display on the right, on the left, in the center, etc. of the cell), the font characteristics (font, size, color, etc.), the border (lines surrounding the cell, etc.) the motifs (background color, background texture, etc.).

A spreadsheet program can be used to define whether or not a cell is protected, that is to say whether or not its content may be modified by a user.

Whatever the situation, the formatting and the protection are attributes of the cells. They are defined individually for each cell. An updating function is used to define these attributes for the database fields. Thus this function makes it possible to avoid having to restrict oneself to formatting or modifying the protection of the cells of the new database records.

This updating function uses at least one parameter line 17, this line having the reference “34” in the spreadsheet shown as an example. Each cell of this line may contain a code or no code. For example, the codes used may be included in the following list: “F”, “FC”, “P”, “UP”, “FP”, “FCP”, “FUP”, “FCUP”.

The application of the updating function consists at least in applying one or more attributes of a cell of the parameter line to the cells of the corresponding database column, the applied attributes being determined by the code.

In this example, the applied attributes are formatting and/or protection attributes.

When a cell of the parameter line contains the code “F”, “FP” or “FUP”, its formatting attributes, with the exception of the color, are applied to the cells of the corresponding column of the database.

Similarly, when a cell of the parameter line contains the code “FC”, “FCP” or “FCUP”, its formatting attributes, including the color, are applied to the cells of the corresponding column of the database. Thus, the text in the cell “G34” being aligned on the left, the same will apply for the cells of the column “G” of the database.

When a cell of the parameter line contains the code “P”, “FP” or “FCP”, the cells of the corresponding column of the database are protected.

When the cell of the parameter line contains the code “UP”, “FUP” or “FCUP”, the cells of the corresponding column of the database are not protected.

Thus, when the applied attributes are formatting attributes (codes containing “F”), these attributes originate from the parameter line cell in question. This makes it possible easily to control the appearance of the fields of a database.

According to the invention, updating functions may also be applied to all the cells of the database. These updating functions are used for example to apply an alternative coloration to the lines of the database, to sort the lines according to determined criteria, to number the records, etc.

The parameters of the updating function allowing an alternate coloration may for example be a whole number and two colors. The function applies the colors alternately to the records, first N lines with the first color, then N lines with the second color, and so on, N being the whole number used as a parameter by this function. In this example, the number N is contained in the cell 14 of the second range of cells. The colors applied to the lines are those of the cells of the lines 15, for example the color of the cell “G31” and the color of the cell “G32”. If the cell 14 contains no number or a zero number, the updating function is not applied to the database.

Another updating function making it possible to sort all the lines of the database is now described. This updating function may use a parameter line, such as the line 19. The cells of the parameter line contain codes, for example the letters “A”, “B”, “C”, etc. The records of the database are sorted by ascending order of the content of the cells of the column containing the code “A”, then by ascending order of the content of the cells of the column containing the code “B”, etc. Thus the primary and secondary sorting keys can be defined so that the lines of the database can be sorted according to an order defined by the content of the determined cells of the second range of cells.

In this example, the records are sorted by ascending order of the content of the column “G”, the only column of the parameter line containing the code “A”. The records of the database are therefore sorted according to the “Group_Name” field.

Another updating function used to number the records (lines) of the database is now described. This updating function consists at least of numbering the lines of the database if a determined code is present in the second range of cells. This code may for example be the letter “R”. It may be situated in the cell 20, also having as its reference “F36” in the spreadsheet shown as an example. The numbering forms a field of the database. This field is preferably that situated under the location marker. If the cell 20 is empty, automatic numbering is not carried out.

Spreadsheet programs are used to name ranges of cells. The names may be used in functions, in particular in the updating functions. They may also be used as arguments in formulae for performing computations. Whatever the situation, the named ranges make it possible to simplify the reference to an range of cells. When a named range of cells increases or decreases, the formulae or functions using this name automatically reflect these modifications.

However, it is necessary to modify the extent of the named ranges of cells making reference to the database or to fields of the database every time a record is added or deleted.

As a result, updating functions may be used to allocate names automatically. A first updating function may allocate a name to the database, that is to say to the first range of cells. The allocated name may be located in a determined cell 13 of the second range of cells.

A second updating function may allocate a name to fields of the database, that is to say to columns of the first range of cells. The name allocated to a column may be determined from that allocated to the database, that is to say from the character string located in the cell 13, to which the name of the field in question is concatenated, that is to say the content of the cell of the first line 5 and of the same column of the first range of cells.

This can be used to allocate a unique name to the columns, even if several databases of one and the same file contain fields of the same name. This also avoids constructing the names with the names of the spreadsheets which allows the names of the spreadsheets to be modified later.

The names accepted by certain spreadsheet programs must comprise only alphanumeric characters, no spaces, and only certain punctuation marks, the other characters being forbidden. In order to comply with this requirement, a character substitution operation can be carried out before allocating names to the ranges of cells in order to replace the disallowed characters in the names of ranges of cells with allowed characters, such as the character “_”.

The method according to the invention may be applied by a command programmed using a programming interface of the spreadsheet program, that is to say an API (“Application Programming Interface”). For example, the updating command may be programmed in Visual Basic in Excel.

The command can apply one or more updating functions described above. For example, the updating command may:
1. name the first range of cells with the name of the database,
2. name the fields of the database,
3. assign validation criteria to the cells of the fields concerned,
4. copy the formulae into the cells of the fields concerned,
5. format and/or protect cells column by column,
6. sort the records of the database according to criteria defined by cells of the second range of cells,
7. number the records if a code is present in a determined cell of the second range of cells,
8. color the lines of the database alternately according to parameters contained in the second range of cells.

The updating method according to the invention may also be applied to data distributed in several different files.

1. A method of updating a database contained in a table that can be processed by a spreadsheet program, the data of the database being located in a first range of cells, update parameters being located in a second range of cells, comprising the steps of: applying to update function and determine set of cells of the first range of cells, each updating function using update parameters included in determined cells of the second range of cells.

2. The method as claimed in claim 1, wherein the second range of cells is placed above the first range of cells in one and the same table.

3. The method as claimed in claim 1, wherein the first range of cells and the second range of cells each containing a location marker, the position of said first and second ranges of cells is determined by finding said markers, the step of determining the position preceding the application of the updating functions.

4. The method as claimed in claim 1, wherein the parameters of at least one determined updating function being located in one or more determined parameter lines, the parameter lines belonging to the second range of cells, this updating function is applied column by column to the cells of the database, the parameters used for updating a column of the database being included in the cells belonging to a corresponding column of the parameter lines.

5. The method as claimed in claim 4, wherein the updating function uses a parameter line, each cell of the line being able to contain a formula or no formula, the updating function being applied to the database cells located in the columns for which the corresponding cell of the parameter line effectively contains a formula, the application of the updating function, including at least for each of these columns, in copying the formula contained in said corresponding cell of the parameter line into the cells of the database column in question.

6. The method as claimed in claim 4, wherein the updating function uses a parameter line, each cell of the line being able to contain a reference to a validation list, the updating function being applied to the database cells located in the columns for which the corresponding cell of the parameter line effectively contains a reference to a validation list, the application of the updating function, including at least for each of these columns, in assigning the validation list whose name is contained in said corresponding cell of the parameter line into the cells of the database column in question.

7. The method as claimed in claim 4, wherein the updating function uses at least one parameter line, each cell of this line being able to contain a code or no code, the application of the updating function including at least in applying one or more determined attributes to the cells of the corresponding database column, the attributes applied being determined by the code.

8. The method as claimed in claim 7, wherein the attributes applied are formatting and/or protection attributes.

9. The method as claimed in claim 8, wherein, when the attributes applied are formatting attributes, these attributes originate from the cell in question of the parameter line.

10. The method as claimed in claim 1, wherein at least one determined updating function is applied line by line to all the cells of the database.

11. The method as claimed in claim 10, wherein the updating function includes at least in applying an alternative coloration to the lines of the database.

12. The method as claimed in claim 10, wherein the updating function includes at least in sorting the lines of the database according to an order defined by the content of the determined cells of the second range of cells.

13. The method as claimed in claim 10, wherein the updating function includes at feast in numbering the lines of the database if a determined code is present in the second range of cells, the numbering forming a field of the database.

14. The method as claimed in claim 10, wherein the updating function includes at least in allocating a name to the first range of cells based on the content of a determined cell of the second range of cells.

15. The method as claimed in claim 10, wherein the updating function includes at least in allocating a name to columns of the first range of cells, the names being determined based on the content of a determined cell of the second range of cells on the one hand, and on the content of the cell of the first line and of the same column of the first range of cells.
